(19) United States
(12) Patent Application Publication
(10) Pub. No.: US 2021/0184371 A1
(43) Pub. Date: Jun. 17, 2021

(54) ANTENNA ARRAYS, DISPLAY MODULES, AND PORTABLE ELECTRONIC DEVICES

(71) Applicant: Sony Corporation, Tokyo (JP)

(72) Inventors: Zhinong YING, Lund (SE); Kun ZHAO, Stockholm (SE)

(21) Appl. No.: 17/054,575

(22) PCT Filed: Jun. 13, 2018
(86) PCT No.: PCT/IB2018/054305

§ 371 Date: Nov. 11, 2020

(51) Int. Cl. H01Q 21/08; H01Q 9/04

(52) U.S. Cl. CPC H01Q 21/08; H01Q 9/0407

(57) ABSTRACT

An antenna array is disclosed. The antenna array comprises a plurality of antenna elements forming part of a transparent antenna layer, wherein the transparent antenna layer is made of an optically transparent conductive material, wherein the plurality of antenna elements comprises a first antenna element and a second antenna element serially connected to the first antenna element via a transmission line.

The present disclosure pertains to the field of wireless communications. More specifically, the present disclosure relates to antenna arrays, display modules, and portable electronic devices.

### BACKGROUND

Antennas are nowadays integrated in the housings of the portable electronic devices. As portable electronic devices increase in complexity by including many sensors and other components, space in the housing becomes more and more scarce.

There is a need for improving the antenna spherical coverage for satisfying the requirements of the wireless communication systems. Such requirements are difficult to meet especially for portable electronic devices with the space constraints discussed.

Placing the antenna in a display part of the portable electronic device that has been a possibility contemplated. However, such a placement poses various challenges in achieving antenna efficiency and spherical coverage while maintaining sufficient transparency of the display part.

### SUMMARY

Accordingly, there is a need for antenna arrays, display modules and portable electronic devices, which overcome, mitigate or alleviate the challenges in achieving antenna efficiency and spherical coverage while maintaining sufficient transparency of the display modules.

An antenna array is disclosed herein. The antenna array comprises a plurality of antenna elements forming part of a transparent antenna layer. The transparent antenna layer is made of an optically transparent conductive material. The plurality of antenna elements comprises a first antenna element and a second antenna element serially connected to the first antenna element via a transmission line.

It is an advantage of the disclosed antenna array that sufficient transparency and an acceptable antenna performance is achieved by providing series connected antenna elements which do not require an underlying complicated feeding network. This thereby results in reducing the spatial usage of the antenna array on a display module and in a portable electronic device and increases the transparency of the antenna array disclosed. Further, it may be appreciated that the antenna array disclosed herein allows achieving an acceptable performance in terms of antenna gain and/or of spherical coverage (e.g. for wireless communications, e.g. for wireless cellular communications, e.g. for new radio communications above 6 GHz).

Further, the present disclosure provides a display module comprising a front glass element and an antenna array disclosed herein.

The present disclosure advantageously enables a display module to include an antenna array that achieves antenna efficiency and sufficient transparency.

The present disclosure provides a portable electronic device comprising a display comprising a first antenna array disclosed herein, a memory module, a wireless communication module operatively connected to the antenna array, and a processor operatively connected to the wireless communication module, the display module and the memory module.

The present disclosure is particularly advantageous for portable electronic device equipped with a full display device because the spherical coverage of the disclosed antenna array comprised in the portable electronic device is improved while transparency for the display is maintained.

The present disclosure advantageously allows saving space within the portable electronic device, which can be used for other purposes, like more components and sensors or for a reducing the size of the portable electronic device, or for being equipped with a full display module.

The display modules, the portable electronic devices provide advantages corresponding to the advantages already described in relation to the antenna arrays.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 schematically illustrates an exemplary antenna array according to the disclosure,

FIG. 2 schematically illustrates an exemplary antenna array with two feeding ports according to the disclosure,

FIG. 3 schematically illustrates an exemplary display module according to the disclosure,

FIG. 4 is a block diagram of an exemplary portable electronic device according to the disclosure,

FIG. 5 schematically illustrates an exemplary portable electronic device according to the disclosure,

FIG. 6 schematically illustrates an exemplary portable electronic device according to the disclosure, and

FIGS. 7A-7C schematically illustrate exemplary antenna arrays with a mesh structure and a solid structure respectively according to the disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which are essential to the understanding of the invention, while other details have been left out. Throughout, the same reference numerals are used for identical or corresponding parts.

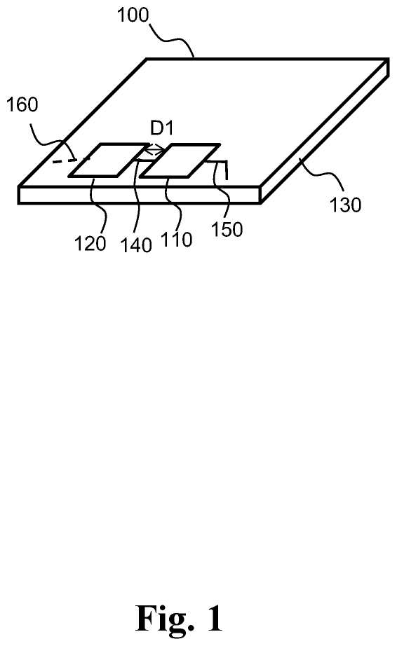

FIG. 1 is a diagram of an exemplary antenna array 100 according to the disclosure.

The antenna array 100, comprises a plurality of antenna elements 110, 120 forming part of a transparent antenna layer 130.

The transparent antenna layer 130 is made of an optically transparent conductive material. In other words, the transparent antenna layer is a layer of optically transparent conductive material and comprises a plurality of antenna elements 110, 120 formed in the transparent antenna layer. The transparent conductive material may be referred to herein as substrate in the present disclosure.

In one or more exemplary antenna arrays, the optically transparent conductive material comprises a transparent conductive polymer and/or a semiconductor oxide. For example, the semiconductor oxide comprises a transparent conductive oxide, e.g. one or more of: indium tin oxide (ITO), indium gallium zinc oxide (IGZO), and silver-coated polyester films (AgHT). For example, a transparent conductive polymer comprises a thin film of optically transparent and electrically conductive material comprising one or more of: indium tin oxide (ITO), wider-spectrum transparent conductive oxides (TCO), conductive polymers, metal grids, carbon nanotubes (CNT), graphene, and nanowire meshes.

For example, the optically transparent conductive material comprises a metal on a glass substrate, such as a copper on a glass substrate, such as silver on a glass substrate wherein a plurality of holes formed in a glass substrate are filled with a metal to act as a conductor. The glass substrate includes for example: low temperature cofired ceramic (LTCC) substrate. This may lead to an improved conducting layer for the antenna array, and a reduced loss (compared with conventional soldering methods).

The plurality of antenna elements 110, 120 comprises a first antenna element 110 and a second antenna element 120 serially connected to the first antenna element 110 via a transmission line 140. Stated differently, the plurality of antenna elements 110, 120 forms a serial antenna array. The first antenna element 110 and the second antenna element 120 are connected in series, or by a series connection, using transmission line 140. The transmission line 140 may be seen as a series connection between the first antenna element 110 and the second antenna element 120.

The antenna array 100 comprises a first feeding port 150 connected to the first antenna element 110. The first feeding port 150 may be connected to a printed circuit board of a radio transceiver module. In one or more exemplary antenna arrays, the radio transceiver may form part of the antenna array. Alternatively, the radio transceiver may form part of a portable electronic device. The first feeding port 150 comprises at least a part that serves as a connection point or a connection portion to the first antenna element 150, wherein the part forms part of the transparent antenna layer 130.

The disclosed antenna array ensures a satisfactory transparent property because the series connected antenna elements permit avoiding using underlying complicated feeding network (which takes more space on display and reduce the transparency). Further, the disclosed antenna array with serial transmission line achieves an acceptable gain (e.g. 5-10 dBi, e.g. 8 dBi) for wireless communication, e.g. for cellular communication, e.g. for 3GPP communication systems (e.g. for new radio systems).

The present disclosure permits to provide an antenna array with serial connected antenna elements or an antenna array system comprising the disclosed antenna array that achieves less loss in the feeding network comparing to an antenna array with phased antenna elements, because the feeding network to control the antenna array disclosed herein can be performed using a switch (which results in a lower structural complexity than using phase shifters). A feeding network with switch is simpler than a feeding network with phase shifters since an antenna array with phased antenna elements requires a phase shifter for each antenna element.

This further supports in realizing an antenna array that satisfies better transparency requirements for integrating the antenna array in a display module. The antenna array disclosed herein permits an integration on different layers inside a display module, (e.g. below a front glass element, below a touch sensor, above a liquid crystal display (LCD) panel element).

The disclosed antenna array is particularly advantageous for embedding in a portable electronic device with a full display (e.g. a full edge display, and/or a so-called “borderless” display, and/or a bezel-less display and/or an edge-to-edge display), because the spectral coverage is improved by the antenna array while transparency is maintained.

In one or more exemplary antenna arrays, an antenna element of the plurality of antenna elements 110, 120 comprise a planar antenna array element. For example, the first antenna element 110 and/or the second antenna element 120 comprise a planar antenna array element (e.g. a patch antenna array element). A planar antenna array element may comprise a planar monopole antenna element. A planar antenna array element as an antenna element of the plurality of antenna elements 110, 120 provides a simple structure which achieves an acceptable antenna gain.

In one or more exemplary antenna arrays, an antenna element comprises a planar loop antenna element, and/or a planar inverted-F antenna (PIFA) element. In one or more exemplary antenna arrays, the antenna element comprises an antenna structure that is planar or sufficiently planar to fit into the transparent antenna layers (e.g. for possible embedding in a display module), such as one or more of: an inverted-F antenna (IFA), and a monopole type.

In one or more exemplary antenna arrays, a dimension of the antenna element is half a wavelength. For example, a planar antenna array element is configured to have a side of a half wavelength in length (e.g. electrical length, or in the substrate forming the transparent antenna layer). The term wavelength refers to the wavelength of a radiation emitted by the antenna array at a frequency. The wavelength may relate to an electromagnetic radiation emitted by the antenna array in air or in the substrate or optically transparent conductive material. The wavelength of electromagnetic radiation is dependent on the material it traverses (according to the permeability and permittivity of the material). The material may be air or optically transparent conductive material.

In one or more exemplary antenna arrays, a dimension of the antenna element is based on the wavelength of the radiation emitted by the antenna element. Depending on the structure of the antenna array element, the dimension may vary so as to achieve a desired electrical length based on the wavelength. For example, for a PIFA or IFA antenna element, the dimension is a quarter of a wavelength of the antenna radiation.

In one or more exemplary antenna arrays, the antenna array 100 is configured to operate in a frequency band ranging from 6 GHz to 100 GHz. In other words one or more exemplary antenna arrays, the antenna array is configured to operate in a frequency range of [6-100 GHz]. The dimension of the antenna element may have a size, such as a length or a width of half a wavelength derived based on a frequency range of [6-100 GHz].

In one or more exemplary antenna arrays, the antenna array is configured to perform millimetre-wave wireless communications.

In one or more exemplary antenna arrays, the antenna array comprises an open end 160 connected to the second antenna element 120. An antenna array with an open end configuration as disclosed herein can be seen as improving antenna efficiency because there is no resistor at the corresponding end to absorb energy. The simplicity of a structure with an open end 160 is seen as advantageous for transparency because there is no need for two feeding ports and corresponding structures. In one or more exemplary antenna arrays, the open end 160 is connectable to a ground.

In one or more exemplary antenna arrays, the first antenna element 110 and the second antenna element 120 are distanced by a spacing distance D1 which is determined based on a steering angle of a target radiation pattern, e.g. a solid angle to be covered by a target radiation pattern of the antenna array disclosed. For example, the first antenna element 110 and the second antenna element 120 are positioned at a spacing distance D1 determined based on the target spherical coverage to be achieved by the antenna array 100. Controlling the spacing distance D1 between each two antenna elements results in controlling a phase shift value of each antenna element. This advantageously may lead to simulating a phased antenna array, and thereby to achieve antenna beam steering.

Spacing distance D1 may be determined based on one or more of the following metrics satisfying a criterion (e.g. above a threshold value): an antenna gain, an effective radiated power, an Effective Isotropic Radiated Power, also called the Equivalent Isotropic Radiated Power (EIRP), a measured radiated power in a single direction, a maximum value of the EIRP over all measured angles, an amount of power that a perfectly isotropic antenna needs to radiate to achieve the measured EIRP value, and an antenna output power for a required sensitivity threshold with respect to each polarization component.

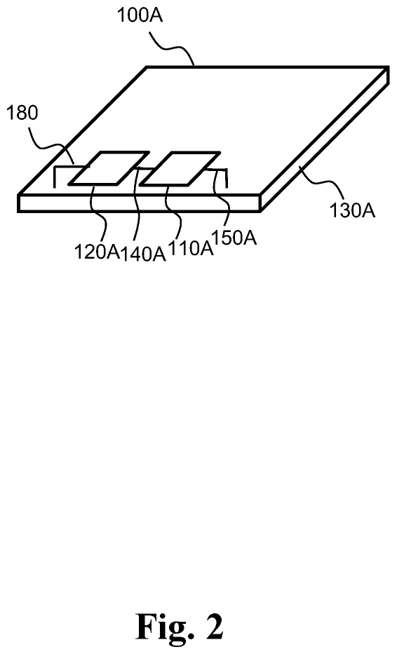

FIG. 2 is a diagram of an exemplary antenna array 100A according to the disclosure. The antenna array 100A, comprises a plurality of antenna elements 110A, 120A forming part of a transparent antenna layer 130A. The plurality of antenna elements 110A, 120A comprises a first antenna element 110 and a second antenna element 120A serially connected to the first antenna element 110A via a transmission line 140A. The antenna array 100A comprises a first feeding port 150A connected to the first antenna element 110A.

The antenna array 100A comprises a second feeding port 180 connected to the second antenna element 120A. For example, the antenna array 100A is configured to terminate the second feeding port 180 when the first feeding port 150A is used and vice versa. The second feeding port 180 may be connected to a printed circuit board of a radio transceiver module of a portable electronic device or any other device where the antenna array is integrated. The radio transceiver module may comprise an antenna controller configured to control any of the first feeding port 150A and the second feeding port 180 based on a target radiation pattern to be achieved (e.g. a target antenna gain of 8-9 dBi).

The present disclosure relates to an antenna array system comprising the disclosed antenna array, and a feeding network comprising a switch module.

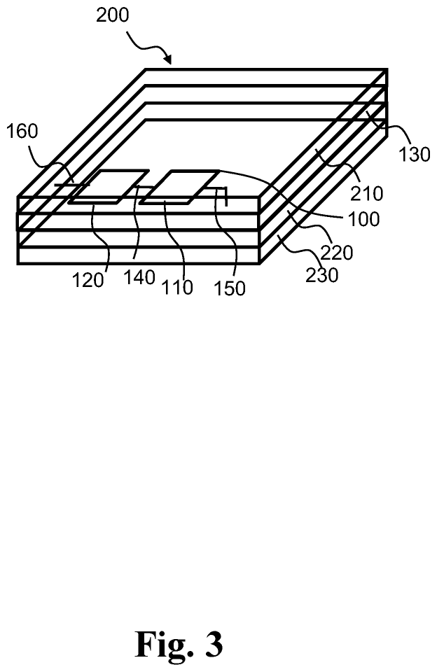

FIG. 3 is a diagram of an exemplary display module 200 according to the disclosure. The display module 200 comprises a front glass element 210. An example of display module 200 may comprise an organic light-emitting diode (OLED) display module. An example of display module 200 may include a full display module, e.g. an edge-to-edge display module.

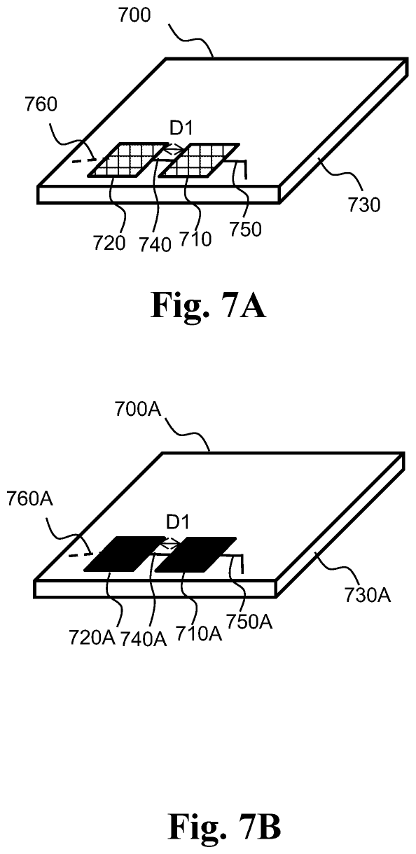

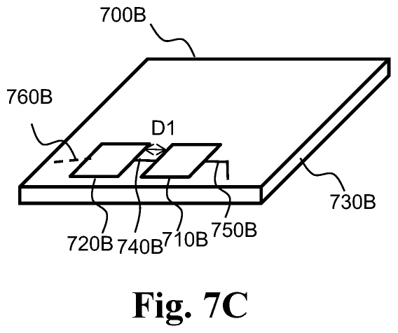

The display module 200 comprises an antenna array disclosed herein (e.g. any one or more exemplary antenna arrays 100 of FIG. 1, any one or more exemplary antenna arrays 100A of FIG. 2, and/or one or more exemplary antenna arrays 700, 700A, 700B of FIGS. 7A-7C). The antenna array 100 may be integrated in the display module 200. The antenna array 100 comprises a first antenna element 110 and a second antenna element 120 serially connected to the first antenna element 120 via the transmission line 140. The first antenna element 110 and the second antenna element 120 may form part of a transparent antenna layer 130.

The display module 200 may comprise one or more of: a display panel element 220 (e.g. a liquid crystal display panel element), and a printed circuit board 230, and optically clear adhesive (OCA) between any two layers. The display module 200 optionally comprises a touch sensor (not shown) and/or a polarizer (not shown).

The antenna array 100A may be placed between the front glass element 210 and the printed circuit board 230, such as between the front glass element 210 and the display panel element 220. The transparent antenna layer 130 may be placed between the front glass element 210 and the printed circuit board 230, such as between the front glass element 210 and the display panel element 220.

In one or more exemplary display modules, where the display module 200 comprises a touch sensor, antenna array 100, 100A may be placed between the touch sensor and the printed circuit board 230. The first feeding port 150 and/or the open end 160 may be connectable to the printed circuit board 230.

In one or more exemplary display modules, the antenna array 100A of FIG. 2 may be integrated in the display module 200. The antenna array 100A may form part of a transparent antenna layer 130A. The first feeding port 150A and/or the second feeding port 180 may be connectable to the printed circuit board 230.

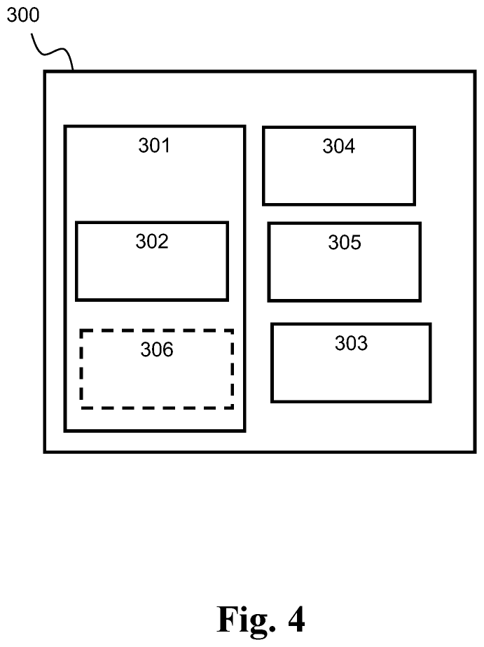

FIG. 4 is a block diagram of an exemplary portable electronic device 300 according to the disclosure. The portable electronic device 300 comprises a display module 301. The display module 301 comprises a first antenna array 302 disclosed herein (e.g. any one or more exemplary antenna arrays 100 of FIG. 1, any one or more exemplary antenna arrays 100A of FIG. 2, and/or one or more exemplary antenna arrays 700, 700A, 700B of FIGS. 7A-7C). The display module 301 is for example a display module that covers an entire real estate of a side of the portable electronic device (also called full display). The first antenna array 302 comprises a plurality of antenna elements (e.g. as illustrated of FIGS. 1-2 and 7A-7C) forming part of a transparent antenna layer. The plurality of antenna elements comprises a first antenna element and a second antenna element serially connected to the first antenna element via a transmission line. The antenna array comprises a first feeding port connected to the first antenna element.

The portable electronic device 300 comprises a memory module 303, a wireless communication module 304 operatively connected to the antenna array 302, a processor 305 operatively connected to the wireless communication module 304, the display module 301 and the memory module 303.

The wireless communication module 304 is optionally configured to communicate in a frequency band ranging from 6 GHz and 100 GHz. The wireless communication module 304 may comprise a radio transceiver module configured to control the first antenna array. The radio transceiver module may comprise an antenna controller configured to control any of the first feeding port 150A and the second feeding port 180 based on a target radiation pattern to be achieved (e.g. a target antenna gain of 8-9 dBi).

In one or more exemplary portable electronic devices, the display module 301 comprises a second antenna array 306. The second antenna array 306 comprises a plurality of antenna elements (e.g. as illustrated of FIGS. 1-2 and 7A-7C) forming part of a transparent antenna layer. The plurality of antenna elements comprises a first antenna element and a second antenna element serially connected to the first antenna element via a transmission line. The antenna array comprises a first feeding port connected to the first antenna element. Having a second antenna array in the portable electronic device achieves multiple beams.

In one or more exemplary portable electronic devices, the first antenna array 302 is configured to produce a first signal with a first polarization in a first direction. In one or more exemplary portable electronic devices, the second antenna array 306 is configured to produce a second signal with a second polarization in a second direction orthogonal to the first direction. This allows a control of polarization (to achieve dual polarization) and enable applying multiple input multiple output (MIMO) techniques, diversity techniques.

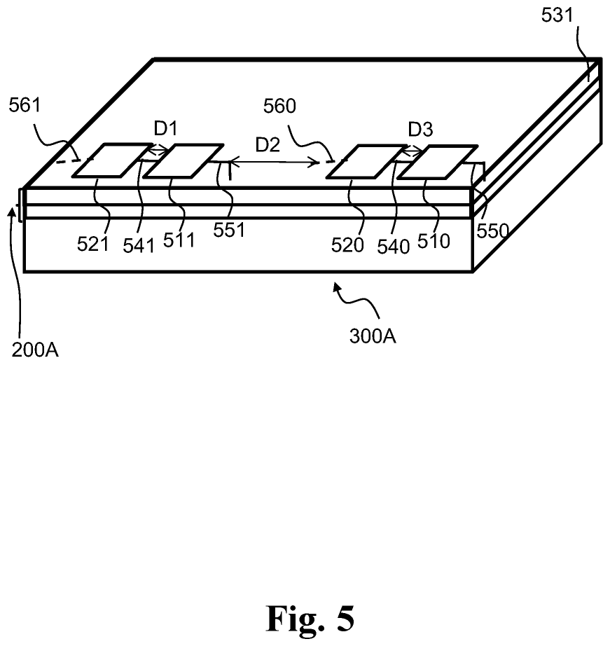

FIG. 5 shows a diagram of an exemplary portable electronic device 300A according to the disclosure. The portable electronic device 300A comprises a display module 200A. The display module 200A comprises a first antenna array and a second antenna array. The first antenna array comprises a first antenna element 511 and a second antenna element 521 serially connected to the first antenna element 511 via the transmission line 541. The first antenna element 511 and the second antenna element 521 may form part of a transparent antenna layer 531 and may be positioned at a spacing distance D1 from one another. The first antenna array comprises a first feeding port 551, and optionally an open end 561. The display module 200A comprises the transparent antenna layer 531.

The second antenna array comprises a first antenna element 510 and a second antenna element 520 serially connected to the first antenna element 510 via the transmission line 540. The first antenna element 510 and the second antenna element 520 may form part of the transparent antenna layer 531 which is in common with the first antenna array. The first antenna element 510 and the second antenna element 520 may be positioned at a spacing distance D3 from one another. The second antenna array comprises a first feeding port 550, and optionally an open end 560.

The first antenna array is positioned at a distance D2 from the second antenna array. This exemplary embodiment may be seen as supporting a demand for multiple beams in the portable electronic device 300A.

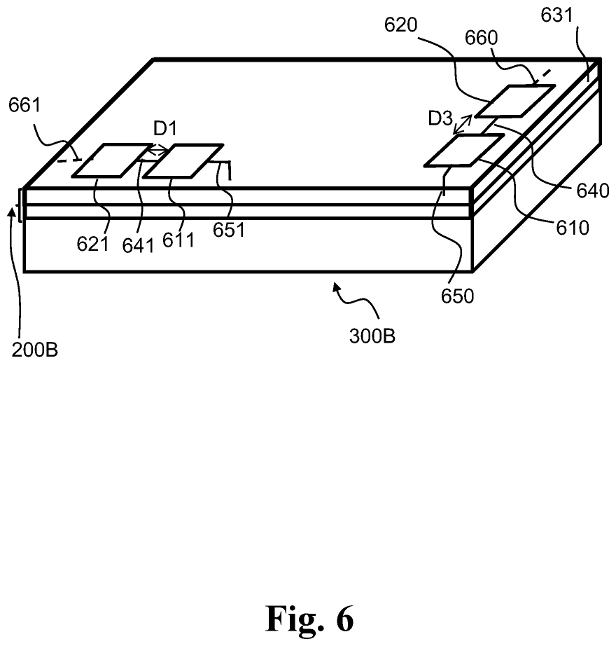

FIG. 6 shows a diagram of an exemplary portable electronic device 300B according to the disclosure. The portable electronic device 300B comprises a display module 200B. The display module 200B comprises a first antenna array and a second antenna array. The first antenna array comprises a first antenna element 611 and a second antenna element 621 serially connected to the first antenna element 611 via the transmission line 641. The first antenna element 611 and the second antenna element 621 may form part of a transparent antenna layer 631 and may be positioned at a spacing distance D1 from one another. The first antenna array comprises a first feeding port 651, and optionally an open end 661. The display module 200B comprises the transparent antenna layer 631.

The second antenna array comprises a first antenna element 610 and a second antenna element 620 serially connected to the first antenna element 610 via the transmission line 640. The first antenna element 610 and the second antenna element 620 may form part of the transparent antenna layer 631 which is in common with the first antenna array. The first antenna element 610 and the second antenna element 620 may be positioned at a spacing distance D3 from one another. The second antenna array comprises a first feeding port 650, and optionally an open end 660.

The first antenna array is configured to produce a first signal with a first polarization in a first direction. In one or more exemplary portable electronic devices, the second antenna array is configured to produce a second signal with a second polarization in a second direction orthogonal to the first direction. This provides allows a control of signal polarizations (e.g. to achieve dual polarization) and enable applying multiple input multiple output (MIMO) techniques, and/or antenna diversity techniques.

FIGS. 7A-7C are diagrams of exemplary antenna arrays 700 and 700A according to the disclosure.

The antenna array 700 comprises a first antenna element 710 and a second antenna element 720 serially connected to the first antenna element 710 via the transmission line 740. The first antenna element 710 and the second antenna element 720 may form part of the transparent antenna layer 730 which is in common with the first antenna array. The first antenna element 610 and the second antenna element 720 may be positioned at a spacing distance D1 from one another. The antenna array 700 comprises a first feeding port 750, and optionally an open end 760. The antenna element 710, 720 of the plurality of antenna elements has a mesh structure. A mesh structure of one or more antenna elements aims at finding an acceptable trade-off between transparency and spectral efficiency.

In one or more exemplary antenna arrays, the transparent antenna layer 730 comprises a transparent substrate and a meshed structure embedded in the transparent substrate to form the first antenna element 710 and the second antenna element 720 serially connected to the first antenna element 710 via a transmission line 740. Optionally, a linewidth of the meshed structure of the first antenna element 710 is in the order of microns. Optionally, the linewidth of the meshed structure of the second antenna element 720 is in the order of microns.

The antenna array 700A of FIG. 7B comprises a first antenna element 710A and a second antenna element 720A serially connected to the first antenna element 710A via the transmission line 740A. The first antenna element 710A and the second antenna element 720A may form part of the transparent antenna layer 730A which is in common with the first antenna array. The first antenna element 710A and the second antenna element 720A may be positioned at a spacing distance D1 from one another. The antenna array 700A comprises a first feeding port 750A, and optionally an open end 760A. The antenna element 710A, 720A of the plurality of antenna elements has a solid structure. For example, the first antenna element 710A has a solid structure. For example, the second antenna element 720A has a solid structure.

A solid structure of one or more antenna elements 710A, 720A trades off transparency for spectral efficiency. A solid structure can achieve an improved radiation pattern over a hollow structure.

The antenna array 700B of FIG. 7C comprises a first antenna element 710B and a second antenna element 720B serially connected to the first antenna element 710B via the transmission line 740B. The first antenna element 710B and the second antenna element 720B may form part of the transparent antenna layer 730B which is in common with the first antenna array. The first antenna element 710B and the second antenna element 720B may be positioned at a spacing distance D1 from one another. The antenna array 700B comprises a first feeding port 750B, and optionally an open end 760B. The antenna element 710B, 720B of the plurality of antenna elements has a hollow structure. For example, the first antenna element 710B has a hollow structure. For example, the second antenna element 720B has a hollow structure.

For example, the first antenna element 710B and/or the second antenna element 720B is ring-shaped. A hollow structure of one or more antenna elements 710B, 720B may lead to a lower antenna efficiency to achieve an increase in transparency of the antenna array 700B. In the one or more exemplary antenna arrays where the antenna element 710B, 720B of the plurality of antenna elements has a hollow structure, the transparent antenna layer is selected from a higher conductive transparent material with lower transparency property.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-7C comprises some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

Although features have been shown and described, it will be understood that they are not intended to limit the claimed subject matter, and it will be made obvious to those skilled in the art that various changes and modifications may be made without departing from the spirit and scope of the claimed invention. The specification and drawings are, accordingly to be regarded in an illustrative rather than restrictive sense. The claimed subject matter is intended to cover all alternatives, modifications, and equivalents.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

1. An antenna array, the antenna array comprising:
a plurality of antenna elements forming part of a transparent antenna layer, wherein the transparent antenna layer is made of an optically transparent conductive material, wherein the plurality of antenna elements comprises a first antenna element and a second antenna element serially connected to the first antenna element via a transmission line, and
a first feeding port connected to the first antenna element.

2. The antenna array according to claim 1, wherein an antenna element of the plurality of antenna elements comprise a planar antenna array element.

3. The antenna array according to claim 1, wherein the optically transparent conductive material comprises a transparent conductive polymer or a semiconductor oxide.

4. The antenna array according to claim 1, the antenna array comprising an open end connected to the second antenna element.

5. The antenna array according to claim 1, the antenna array comprising a second feeding port connected to the second antenna element.

6. The antenna array according to claim 1, wherein the first antenna element and the second antenna element are distanced by a spacing distance D1 which is determined based on a steering angle of a target radiation pattern of the antenna array.

7. The antenna array according to claim 1, wherein an antenna element of the plurality of antenna elements has a mesh structure or a solid structure.

8. The antenna array according to claim 1, wherein the antenna array is configured to operate in a frequency band ranging from 6 GHz to 100 GHz.

9. A display module comprising:
a front glass element, and
the antenna array according to claim 1.

10. A portable electronic device comprising:
a display module comprising a first antenna array being the antenna array according to claim 1,
a memory module,
a wireless communication module operatively connected to the antenna array,
a processor module operatively connected to the wireless communication module, the display module and the memory module.

11. A portable electronic device according to claim 10, wherein the display module comprises a second antenna array being another antenna array structurally configured in the same manner as the first antenna array.

12. The portable electronic device according to claim 10, wherein the first antenna array is configured to produce a first signal with a first polarization in a first direction and wherein the second antenna array is configured to produce a second signal with a second polarization in a second direction orthogonal to the first direction.
